(19) United States
(12) Patent Application Publication
(10) Pub. No.: US 2008/0307763 A1
(43) Pub. Date: Dec. 18, 2008

(54) Universal Cutting Device for Portable Trimmers

(75) Inventors: Marco Paolo Correia De Sa Portocarrero, Caminha (PT); Joao Francisco Machado Gomes Da Silva, Gondomar (PT); Antonio Torres Marques, Matosinhos (PT)

Correspondence Address: SUGHRUE MION, PLLC, 2100 PENNSYLVANIA AVENUE, N.W., SUITE 800, WASHINGTON, DC, 20037, US

(73) Assignee: INEGI-INSTITUTO DE ENGENHARIA MECANICA E GESTAO INDUSTRIAL, Leca do Balio (PT)

(21) Appl. No.: 11/665,150

(22) PCT Filed: Oct. 18, 2005
(86) PCT No.: PCT/IB2005/053416

§ 371 Date: Jan. 17, 2008

(30) Foreign Application Priority Data
Oct. 19, 2004 (PT) 103203

(51) Int. Cl. A01D 34/73

(52) U.S. Cl. 56/255

(57) ABSTRACT

The object of the invention is a cutting device to be used with portable trimmers, made by a rigid disc (1) where several centrifugal cutting blades (2) are conveniently fixed. This device can be used with any existing portable trimmers. Also, this device can efficiently cut virtually any kind of vegetation, from small grass to small trees. It was designed to keep cutting with efficiency even after several hard impacts against extremely hard objects, such as stones.

### FIELD OF INVENTION

Universal cutting device for portable clearing equipments.

### STATE OF THE ART

Portable trimmers are devices with a thermal combustion engine that transmits rotational motion trough an axis which can have different lengths, to a device, allowing the cut of different kinds of vegetation.

Today, there are several kinds of said cutting devices, distinguished, among other features, by:

1. accessories for grass cutting:
1. several models of twine heads working with several lines, generally of polymeric material (polyamide);
2. knife heel head coupled to the trimmer, only trough one side, and works by using the centrifugal force on the mentioned plastic blades which are fixed with bearings or metallic bushes.
   2. accessories for heavy grass, although not ligneous:
1. here are several variants of rigid disks with three or more teeth made with different heights for the different vegetation to cut;
2. disks allowing the substitution of blades rigidly fixed therein;
3. rigid blade, folded on both ends, specially designed for the grinding of non ligneous vegetation;
   3. accessories for cutting small trees:
1. circular blades with different teeth configurations that can include diamond materials
2. chains similar to the ones used in power chainsaws, placed on a rigid device.

### DETAILED DESCRIPTION OF THE INVENTION

The object of the invention is a cutting device for portable trimmers and that can be coupled to any portable trimmer model commercially available. It allows cleaning (by cutting) efficiently any kind of vegetation, from grass to small trees.

This device was designed and conceived to keep cutting efficiently even after continuous impacts against hard objects (e.g., stones, iron) generally present in the fields that are invaded with vegetation in general. In the existing accessories for trimmers the said impact against hard objects deeply limits its usable life time constraining an early substitution.

On the other hand, all existing accessories have a specific use, related with the kind of vegetation that they should cut; there are tools for vegetation like grass, others for more fibrous vegetation, others for cutting thin ligneous vegetation and finally, others that allow cutting small trees. The developed device allows, due to its characteristics, the substitution with advantages of all existing accessories by this one that cuts efficiently from small grass to small trees and therefore having productivity profits. The innovative device is made of several metallic blades conveniently fixed to a rigid support and that vary automatically their cutting angle according to the found cutting force. In limit situations (which can arise from the impact against a stone) they can make a complete rotation around their own axis and be able to cut again. The cutting angle results from the balance between the cutting force and the centrifugal one.

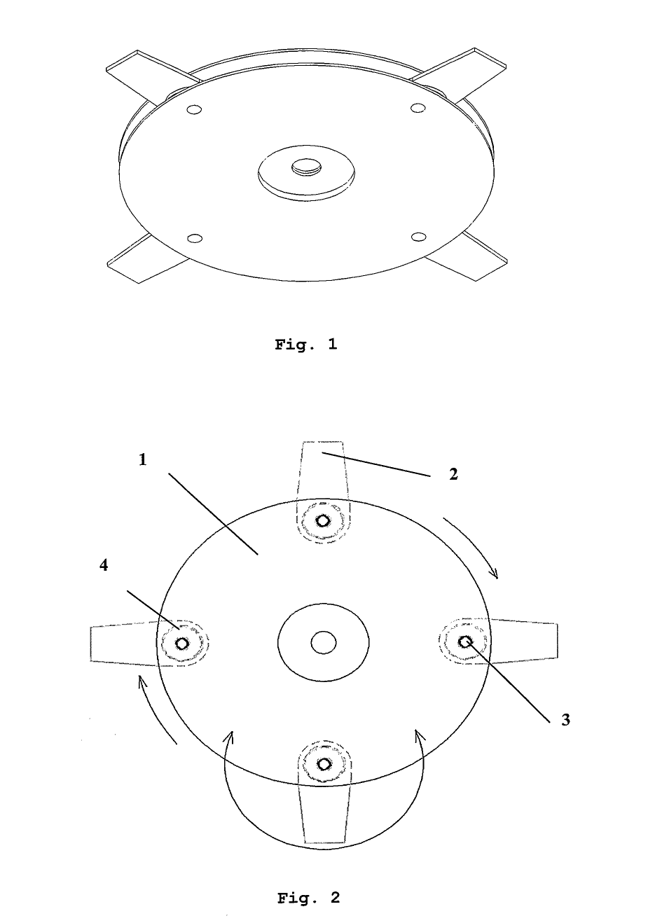

The developed device (see FIG. 1) is made of a main platform (1) with axial symmetry, allowing its use with both sides coupled to the existing trimmers. The cutting blades (in number of two or more) (2) can be fixed to this main system through double bushes—one being made from a friction resistant material (3) fixes the two parts of the main fixing system and a second one (4), made of a material with less friction resistance than the blades or the bushes 3. Thus, any accidental ejection of the blades is excluded.

1. Cutting device to be used with portable trimmers characterized in that it is made up by more than one metallic blades that are fixed to a rigid system with a generic circular shape and for which the cutting angle varies automatically according to the found cutting force, being such defined as a result of the balance between the centrifugal and cutting forces.

2. Cutting device for portable trimmers according to claim 1, characterized in that it is composed by a main axially symmetric fixing system (1) allowing the work with both of it's sides coupled to the commercially available trimmers, where two or more metallic blades are fixed (2) through, at least, two bushes. One (3), made of a friction resistant material should be fixed to the fixing system and the other (4), made of a less friction resistant material than the blade or the bushes referenced (3) and to be manufactured with the appropriated drawing clearances, allowing for a safe and mild work, based on the balance between the centrifugal force and the force required to cut the vegetation.

3. Cutting device for trimmers according to the previous claims characterized in that it can be attached to the trimmer, undistinguishly, from whichever of both sides, allowing an equilibrated blade detrition and therefore extending it's wear-out life.
